(19) United States
(12) Patent Application Publication
(10) Pub. No.: US 2026/0075671 A1
(43) Pub. Date: Mar. 12, 2026

(54) WLAN Peer to Peer connectivity with MBSSID

(71) Applicant: HUAWEI TECHNOLOGIES CO., LTD., Shenzhen (CN)

(72) Inventors: Stephen MCCANN, Ottawa (CA); Ming Gan, Shenzhen (CN); Yuchen Guo, Shenzhen (CN); Michael Montemurro, Ottawa (CA)

(21) Appl. No.: 19/390,830

(22) Filed: Nov. 17, 2025

Related U.S. Application Data
(63) Continuation of application No. PCT/CN2023/094922, filed on May 18, 2023.

(51) Int. Cl. H04W 76/14; H04W 8/00; H04W 8/24

(52) U.S. Cl. CPC H04W 76/14; H04W 8/005; H04W 8/245

(57) ABSTRACT

A method of establishing direct communication between two peer non-access point, non-AP, stations, STAs, in a network environment including a plurality of networks, at least one AP and at least two non-AP STAs, the method comprising: advertising, by the AP, at least two basic service sets, BSSs, wherein the BSSs allow peer to peer, P2P, connectivity; wherein each BSS includes a respective BSS profile, wherein the BSS profile includes an identifier element for identifying P2P capability, P2PID element, thereby advertising the respective BSS for P2P capability; discovering, by the two peer non-AP STAs the P2PID element; and establishing a P2P connection between the two peer non-AP STAs.

### CROSS-REFERENCE TO RELATED APPLICATIONS

This application is a continuation of International Application No. PCT/CN2023/094922, filed on May 18, 2023, the disclosure of which is hereby incorporated by reference in its entirety.

### TECHNICAL FIELD

The present disclosure generally relates to methods and systems the field of Peer to Peer connectivity.

### BACKGROUND

Tunneled Direct Link Setup, TDLS, allows two peer non-access point, non-AP, stations, STAs to establish direct communication with each other. Once a TDLS link has been established, traffic flows directly between the peer STAs and is not bridged through the AP. TDLS can only be established between two STAs associated to the AP in the same basic service set, BSS. The path of a frame is reduced from STA-AP-STA to STA-STA.

IEEE 802.11 includes a feature of a Multiple BSS identifier, MBSSID. An MBSS allows an AP to advertise multiple BSSs, using the MBSSID, that are co-located using a single beacon. The BSSs are connected to separate extended service sets, ESSs/distribution systems, DSs, so it is unclear that they provide connectivity to a single local area network, LAN.

Further, TDLS may allow peer STAs to establish direct communication, but only if they are connected to the same BSS, i.e. the same AP. With the MBSSID feature, peer STAs can be connected on different BSSs to the same AP.

There are numerous use cases where STA to STA communications are useful and do not require a network. For example, file and media sharing, peripheral communication, e.g. external display, and gaming.

Based on IEEE 802.11, technologies such as Wi-Fi direct and independent basic service sets, IBSSs, both may provide direct connectivity between stations, but are cumbersome to configure and manage. Thus, most STA-STA communications occur within coverage of an Access Point.

Discovery and set up frames are typically encapsulated within data frames so they are exchanged between peer STAs through the AP. Thus, the AP does not need to be “TDLS capable”. Once the setup is complete, the two non-AP STAs can communicate directly with each other.

TDLS communications are used in various applications such as screen sharing, and streaming to a display device.

One challenge with peer to peer communications between STAs is that they are limited in which bands they can operate, i.e. they cannot operate in radar, e.g. UNII-2, and 6 GHz bands when neither device can operate as a master device for a given Regulatory Domain.

By establishing connectivity through an AP, the peer devices can at least operate on the same channel that the AP is operating on.

Thus, in view of the above, it is an object of the present disclosure to find an alternative allowing peer STAs to connect when they are associated to different BSSs.

### SUMMARY

Throughout the text of the present disclosure, the terms peer to peer, P2P initiator and P2P initiator STA should be understood synonymously. Further, the terms P2P responder and P2P responder STA should be understood synonymously.

In view of the above, the present disclosure relates to methods and systems for establishing direct communication between two peer non-access point, non-AP, stations, STAs, in a network environment including a plurality of networks.

The present disclosure is defined by the scope of the independent claims. The dependent claims provide advantageous embodiments of the present disclosure.

The present disclosure provides a first aspect of a method of establishing direct communication between two peer non-access point, non-AP, stations, STAs, in a network environment including a plurality of networks, at least one AP and at least two non-AP STAs, the method comprising: advertising, by the AP, at least two basic service sets, BSSs, wherein the BSSs allow peer to peer, P2P, connectivity; wherein each BSS includes a respective BSS profile, wherein the BSS profile includes an identifier element for identifying P2P capability, P2PID element, thereby advertising the respective BSS for P2P capability; discovering, by the two peer non-AP STAs the P2PID element; and establishing a P2P connection between the two peer non-AP STAs.

According to an implementation of the method of the first aspect, in the method, the BSS profile may further include a subfield indicating P2P connectivity, P2P Connectivity Subfield.

According to an implementation of the method of the first aspect, the method may further comprise: in the case that the BSSs are co-located, transmitting, by the AP, separate beacons for each BSS hosted by the AP, wherein advertising by the AP uses separate beacons, wherein each of the separate beacons of the BSS profile includes an element for allowing the AP to advertise BSSs where P2P connectivity is allowed, P2P Connectivity element.

According to an implementation of the method of the first aspect, in the method, the P2P Connectivity element may include at least the following subfields: a subfield indicating the identifier element for identifying P2P capability, P2PID element; the subfield indicating P2P connectivity; a subfield indicating the BSSID of the transmitter, TX BSSID, wherein the TX BSSID is set to the BSSID of the P2P initiator.

According to an implementation of the method of the first aspect, in the method, advertising, by the AP, may use Multiple BSSID, MBSSID, to advertise the at least two BSSs.

According to an implementation of the method of the first aspect, in the method, the BSSID of the transmitter, TX BSSID, may be equivalent to the MBSSID of the AP.

According to an implementation of the method of the first aspect, in the method, the P2P Connectivity Subfield may include one or more of the following properties: a property indicating whether the BSSs advertised by the P2PID element are connected to the same LAN or different LANs; a property indicating whether the P2P connection uses auto-IP in IPV4; and a property indicating whether the P2P connection uses IPv6.

According to an implementation of the method of the first aspect, in the method, the identifier element for identifying P2P may be an identifier for identifying a P2P link, P2P Link Identifier element.

According to an implementation of the method of the first aspect, in the method, the P2P Link Identifier element may include at least the following subfields: a subfield indicating a P2P initiator MAC address; a subfield indicating a P2P responder MAC address; a subfield indicating a BSSID of a P2P transmitter, wherein the BSSID of the P2P transmitter is set depending on the type of the frame to be transmitted: the BSSID of the P2P initiator, in case a TDLS Discovery Request frame is transmitted; the BSSID of the P2P responder, in case a TDLS Discovery Response frame is transmitted; the BSSID of the P2P initiator, in case a TDLS Setup Request or a TDLS Setup Confirm frame is transmitted; the BSSID of the P2P responder, in case a TDLS Setup Response frame is transmitted; and a subfield indicating a TX BSSID for the AP.

According to an implementation of the method of the first aspect, the method may further comprise: one of the two peer non-AP STAs being the initiator of the P2P, the other one of the two peer non-AP STAs being the responder of the P2P, wherein the P2P initiator, the P2P responder and the AP communicate via tunneled direct link setup, TDLS, frames; wherein the method may further comprise: providing, by the P2P initiator, a predefined TDLS Discovery Request frame; modifying the predefined TDLS Discovery Request frame by adding the P2P Link Identifier element to the TDLS Discovery Request frame, thereby obtaining a modified TDLS Discovery Request frame; transmitting, by the P2P initiator, the modified TDLS Discovery request frame to the P2P responder via the AP; matching, by the P2P responder, the received modified TDLS Discovery request frame with the address and TX BSSID of the P2P initiator; directly responding, by the P2P responder, to the P2P initiator, with a TDLS Discovery Response frame using the P2P Link Identifier element; validating, by the P2P initiator, the P2P initiator address and TX BSSID in the received TDLS Discovery Response frame from the P2P responder; providing, by the P2P initiator, a predefined TDLS Setup Request frame; modifying the predefined TDLS Discovery Setup Request frame by adding the P2P Link Identifier element to the TDLS Setup Request, thereby obtaining a modified TDLS Setup Request frame; setting up the P2P link by the P2P initiator by transmitting the modified TDLS Setup Request frame to the P2P responder via the AP; after receiving, by the P2P responder, the modified TDLS Setup Request frame via the AP, responding, by the P2P responder, to the P2P initiator via the AP by sending a TDLS Setup response frame and deriving, by the P2P responder, a TDLS peer key, TPK; receiving, by the P2P initiator, the TDLS Setup Response frame from the P2P responder via the AP, and deriving, by the P2P initiator, the TPK, and responding, by the P2P initiator, to the P2P responder via the AP with a TDLS Setup Confirm frame.

According to an implementation of the method of the first aspect, in the method, the modified TDLS Discovery request frame, the TDLS Setup Request frame, the TDLS Setup Response frame, and the TDLS Confirm frame may be transmitted between the P2P initiator STA and P2P responder STA as management frames according to IEEE 802.11, wherein these management frames comprise subfields according to:

| | | | | | Same | Different |
|---|---|---|---|---|---|---|
| Frame | A1 | A2 | A3 | ToDS/FromDS | LAN | LAN |
| TDLS | Responder | Initiator | Initiator | 1/0 - | Data | Action |
| Discovery | MAC | MAC | MAC | Initiator to | | |
| Request | | | BSSID for | AP | | |
| | | | UL/ | 0/1 - AP to | | |
| | | | Responder | Responder | | |
| | | | MAC | | | |
| | | | BSSID for | | | |
| | | | DL | | | |
| TDLS | Initiator | Responder | Transmitted | 0/0 | Action | Action |
| Discovery | MAC | MAC | BSSID | | | |
| Response | | | | | | |
| TDLS | Responder | Initiator | Initiator | 1/0 - | Data | Action |
| Setup | MAC | MAC | MAC | Initiator to | | |
| Request | | | BSSID for | AP | | |
| | | | UL/ | 0/1 - AP to | | |
| | | | Responder | Responder | | |
| | | | MAC | | | |
| | | | BSSID for | | | |
| | | | DL | | | |
| TDLS | Initiator | Responder | Responder | 1/0 - | Data | Action |
| Setup | MAC | MAC | MAC | Responder | | |
| Response | | | BSSID for | to AP | | |
| | | | UL/ Initiator | 0/1 - AP to | | |
| | | | MAC | Initiator | | |
| | | | BSSID for | | | |
| | | | DL | | | |
| TDLS | Responder | Initiator | Initiator | 1/0 - | Data | Action |
| Setup | MAC | MAC | MAC | Initiator to | | |
| Confirm | | | BSSID for | AP | | |
| | | | DL/ | 0/1 - AP to | | |
| | | | Responder | Responder | | |
| | | | MAC | | | |
| | | | BSSID for | | | |
| | | | UL | | | |
| TDLS | Responder | Transmitter | Transmitted | 0/0 | Data | Data |
| Data | MAC | MAC | BSSID | | | |
| frames | | | | | | |

where A1, A2 and A3 are addresses according to IEEE 802.11, ToDS and FromDS are subfields of the Frame Control field, SameLAN and DifferentLAN indicate the TDLS frame types depending upon whether the two peer non-AP STAs are on the same LAN or are on different LANs, respectively.

According to an implementation of the method of the first aspect, in the method, the deriving of the TPK may comprise: generating an input for deriving the TPK, TPK-Key-Input; deriving the TPK using a predefined key derivation function, KDF, wherein the KDF arguments include the TPK-Key-Input and one or more of: the minimum of the numerical value of the MAC address of the MAC addresses of the P2P initiator and the P2P responder, the maximum of the numerical value of the MAC address of the MAC addresses of the P2P initiator and the P2P responder, the P2P identifier element, the BSSID of the P2P initiator, the BSSID of the P2P responder, and the transmitted BSSID; wherein the BSSID of the P2P initiator is the identifier of the BSS of the respective P2P initiator STA, the BSSID of the P2P responder is the identifier of the BSS of the P2P responder STA.

The present disclosure provides a second aspect of a system for establishing direct communication between two peer non-access point, non-AP, stations, STAs, in a network environment including a plurality of networks, at least one AP and at least two non-AP STAs, wherein: the AP is configured to advertise at least two basic service sets, BSSs, wherein the BSSs allow peer to peer, P2P, connectivity; wherein each BSS includes a respective BSS profile, wherein the BSS profile includes an identifier element for identifying P2P capability, P2PID element, thereby advertising the respective BSS for P2P capability; wherein the two peer non-AP STAs are configured to discover the P2PID element; and the two peer non-AP STAs are configured to establish a P2P connection between the two peer non-AP STAs.

According to an implementation of the system of the second aspect, the BSS profile further may include a subfield indicating P2P connectivity, P2P Connectivity Subfield.

According to an implementation of the system of the second aspect, the system may further comprise: in the case that the BSSs are co-located, the AP is configured to transmit separate beacons for each BSS hosted by the AP, wherein the AP is configured to use separate beacons for advertising, wherein each of the separate beacons of the BSS profile includes an element for allowing the AP to advertise BSSs where P2P connectivity is allowed, P2P Connectivity element.

According to an implementation of the system of the second aspect, the P2P Connectivity element includes at least the following subfields: a subfield indicating the identifier element for identifying P2P capability, P2PID element; the subfield indicating P2P connectivity; a subfield indicating the BSSID of the transmitter, TX BSSID, wherein the TX BSSID is set to the BSSID of the P2P initiator.

According to an implementation of the system of the second aspect, the AP may be configured to use Multiple BSSID, MBSSID, to advertise the at least two BSSs.

According to an implementation of the system of the second aspect, the BSSID of the transmitter, TX BSSID, may be equivalent to the MBSSID of the AP.

According to an implementation of the system of the second aspect, the P2P Connectivity Subfield may include one or more of the following properties: a property indicating whether the BSSs advertised by the P2PID element are connected to the same LAN or different LANs; a property indicating whether the P2P connection uses auto-IP in IPV4; and a property indicating whether the P2P connection uses IPV6.

According to an implementation of the system of the second aspect, the identifier element for identifying P2P may be an identifier for identifying a P2P link, P2P Link Identifier element.

According to an implementation of the system of the second aspect, the P2P Link Identifier element may include at least the following subfields: a subfield indicating a P2P initiator MAC address; a subfield indicating a P2P responder MAC address; a subfield indicating a BSSID of a P2P transmitter, wherein the BSSID of the P2P transmitter is set depending on the type of the frame to be: the BSSID of the P2P initiator, in case a TDLS Discovery Request frame is transmitted; the BSSID of the P2P responder, in case a TDLS Discovery Response frame is transmitted; the BSSID of the P2P initiator, in case a TDLS Setup Request or a TDLS Setup Confirm frame is transmitted; the BSSID of the P2P responder, in case a TDLS Setup Response frame is transmitted; and a subfield indicating a TX BSSID for the AP.

According to an implementation of the system of the second aspect, the system may further comprise: one of the two peer non-AP STAs being the initiator of the P2P, the other one of the two peer non-AP STAs being the responder of the P2P, wherein the P2P initiator, the P2P responder and the AP are configured to communicate via tunneled direct link setup, TDLS, frames; wherein: the P2P initiator is configured to provide a predefined TDLS Discovery Request frame; the P2P initiator is configured to modify the predefined TDLS Discovery Request frame by adding the P2P Link Identifier element to the TDLS Discovery Request frame, thereby obtaining a modified TDLS Discovery Request frame; the P2P initiator is configured to transmit the modified TDLS Discovery Request frame to the P2P responder via the AP; the P2P responder is configured to match the received modified TDLS Discovery Request frame with the address and TX BSSID of the P2P initiator; the P2P responder is configured to directly respond to the P2P initiator, with a TDLS Discovery Response frame using the P2P Link Identifier element; the P2P initiator is configured to validate the P2P initiator address and TX BSSID in the received TDLS Discovery Response frame from the P2P responder; the P2P initiator is configured to provide a predefined TDLS Setup Request frame; the P2P initiator is configured to modify the predefined TDLS Setup Request frame by adding the P2P Link Identifier element to the TDLS Setup Request message, thereby obtaining a modified TDLS Setup Request frame; the P2P initiator is configured to set up the P2P link by transmitting the modified TDLS Setup Request frame to the P2P responder via the AP; the P2P responder is configured to receive the modified TDLS Setup Request frame via the AP, and then to respond to the P2P initiator via the AP by sending a TDLS Setup Response frame and the P2P responder is configured to derive a TDLS peer key, TPK; the P2P initiator is configured to receive the TDLS Setup Response message frame from the P2P responder via the AP, and to derive the TPK, and to respond to the P2P responder via the AP with a TDLS Setup Confirm frame.

Here, it should be noted that the P2P connection is established on successful receipt of the TDLS Setup Confirm.

According to an implementation of the system of the second aspect, the modified TDLS Discovery Request frame, the TDLS Setup Request frame, the TDLS Setup Response frame, and the TDLS Setup Confirm frame may be transmitted between the P2P initiator STA and P2P responder STA as management frames according to IEEE 802.11, wherein these management frames comprise subfields according to:

| | | | | | Same | Different |
|---|---|---|---|---|---|---|
| Frame | A1 | A2 | A3 | ToDS/FromDS | LAN | LAN |
| TDLS | Responder | Initiator | Initiator | 1/0 - | Data | Action |
| Discovery | MAC | MAC | MAC | Initiator to | | |
| Request | | | BSSID for | AP | | |
| | | | UL/ | 0/1 - AP to | | |
| | | | Responder | Responder | | |
| | | | MAC | | | |
| | | | BSSID for | | | |
| | | | DL | | | |
| TDLS | Initiator | Responder | Transmitted | 0/0 | Action | Action |
| Discovery | MAC | MAC | BSSID | | | |
| Response | | | | | | |
| TDLS | Responder | Initiator | Initiator | 1/0 - | Data | Action |
| Setup | MAC | MAC | MAC | Initiator to | | |
| Request | | | BSSID for | AP | | |
| | | | UL/ | 0/1 - AP to | | |
| | | | Responder | Responder | | |
| | | | MAC | | | |
| | | | BSSID for | | | |
| | | | DL | | | |
| TDLS | Initiator | Responder | Responder | 1/0 - | Data | Action |
| Setup | MAC | MAC | MAC | Responder | | |
| Response | | | BSSID for | to AP | | |
| | | | UL/ Initiator | 0/1 - AP to | | |
| | | | MAC | Initiator | | |
| | | | BSSID for | | | |
| | | | DL | | | |
| TDLS | Responder | Initiator | Initiator | 1/0 - | Data | Action |
| Setup | MAC | MAC | MAC | Initiator to | | |
| Confirm | | | BSSID for | AP | | |
| | | | DL/ | 0/1 - AP to | | |
| | | | Responder | Responder | | |
| | | | MAC | | | |
| | | | BSSID for | | | |
| | | | UL | | | |
| TDLS | Responder | Transmitter | Transmitted | 0/0 | Data | Data |
| Data | MAC | MAC | BSSID | | | |
| frames | | | | | | |

where A1, A2 and A3 are address fields according to IEEE 802.11, ToDS and FromDS are subfields of the Frame Control field, SameLAN and DifferentLAN indicate the TDLS frame types depending upon whether the two peer non-AP STAs are on the same LAN or are on different LANs, respectively. 5

According to an implementation of the system of the second aspect, the system may further comprise: the P2P responder being configured to derive the TPK comprises the P2P responder being configured to: generate an input for deriving the TPK, TPK-Key-Input; derive the TPK using a predefined key derivation function, KDF, wherein the KDF arguments include the TPK-Key-Input and one or more of: the minimum of the numerical value of the MAC address of the MAC addresses of the P2P initiator and the P2P responder, the maximum of the numerical value of the MAC address of the MAC addresses of the P2P initiator and the P2P responder, the P2P identifier element, the BSSID of the P2P initiator, the BSSID of the P2P responder, and the transmitted BSSID; wherein the BSSID of the P2P initiator is the identifier of the BSS of the respective P2P initiator STA, the BSSID of the P2P responder is the identifier of the BSS of the P2P responder STA.

According to an implementation of the system of the second aspect, the system may further comprise: the P2P initiator being configured to derive the TPK comprises the P2P initiator being configured to: generate an input for deriving the TPK, TPK-Key-Input; derive the TPK using a predefined key derivation function, KDF, wherein the KDF arguments include the TPK-Key-Input and one or more of: the minimum of the numerical value of the MAC address of the MAC addresses of the P2P initiator and the P2P responder, the maximum of the numerical value of the MAC address of the MAC addresses of the P2P initiator and the P2P responder, the P2P identifier element, the BSSID of the P2P initiator, the BSSID of the P2P responder, and the transmitted BSSID; wherein the BSSID of the P2P initiator is the identifier of the BSS of the respective P2P initiator STA, the BSSID of the P2P responder is the identifier of the BSS of the P2P responder STA.

The present disclosure further provides a third aspect of a system for establishing direct communication between two peer non-access point, non-AP, stations, STAs, in a network environment including a plurality of networks, at least one AP and at least two non-AP STAs, wherein: the AP comprises an advertising unit, wherein the advertising unit is configured to advertise at least two basic service sets, BSSs, wherein the BSSs allow peer to peer, P2P, connectivity; wherein each BSS includes a respective BSS profile, wherein the BSS profile includes an identifier element for identifying P2P capability, P2PID element, thereby advertising the respective BSS for P2P capability; wherein each of the two peer non-AP STAs comprises a discovering unit, wherein the discovering unit of each of the two peer non-AP STAs is configured to discover the P2PID element, respectively; and wherein each of the two peer non-AP STAs comprises a connecting unit, wherein each of the connecting units are configured to establish a P2P connection between the two peer non-AP STAs, respectively.

The present disclosure provides a fourth aspect of a computer program product comprising program code for performing the method according the first aspect when executed on a computer or a processor.

The present disclosure provides a fifth aspect of a non-transitory computer-readable medium carrying a program code which, when executed by a computer device, causes the computer device to perform the method according to the first aspect.

### BRIEF DESCRIPTION OF THE DRAWINGS

In the following, embodiments of the invention are described in more detail with reference to the attached figures and drawings, in which

FIG. 1 illustrates schematically a known example of negotiating a TDLS Peer connection between two legacy STAs.

FIG. 2 illustrates a method of establishing direct communication between two peer non-access point, non-AP, stations, STAs according to an embodiment of the present disclosure.

FIG. 3 illustrates a P2P identifier field for a BSS profile for advertising P2P connectivity, according to an embodiment of the present disclosure.

FIG. 4 illustrates a P2P identifier field similar to the P2P of FIG. 3, the P2P identifier field including a P2P connectivity subfield, according to an embodiment of the present disclosure.

FIG. 5 illustrates a variant of the fields of FIG. 4, included in an element, according to an embodiment of the present disclosure.

FIG. 6 illustrates an example for a P2P connectivity subfield according to an embodiment of the present disclosure.

FIG. 7 illustrates an example for a P2P Link Identifier element, according to an embodiment of the present disclosure.

FIG. 8 illustrates a variant of the P2P Link Identifier element of FIG. 7, according to an embodiment of the present disclosure.

FIG. 9 illustrates details of a protocol flow showing establishment of a P2P connection, according to an embodiment of the present disclosure.

FIG. 10 illustrates a table including specific addressing with respect to the frames shown in FIG. 9.

FIG. 11 illustrates an example of a P2P Connectivity element according to another embodiment of the present disclosure.

FIG. 12 illustrates a system for establishing direct communication between two peer non-access point, non-AP, stations, STAs according to an embodiment of the present disclosure, according to an embodiment of the present disclosure.

### DESCRIPTION

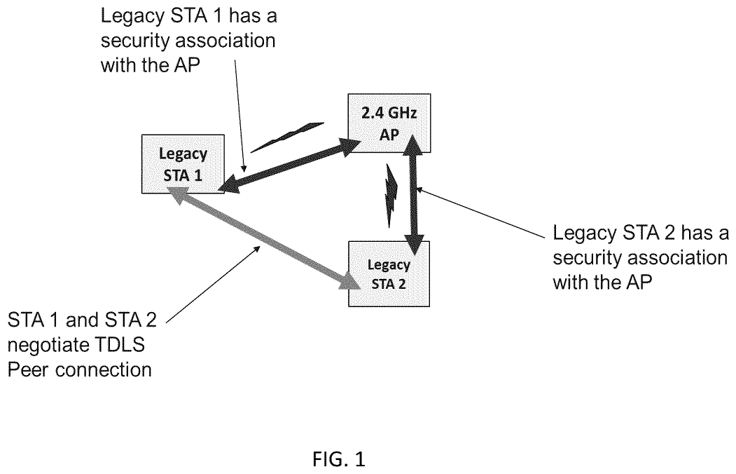

FIG. 1 illustrates schematically a known example of negotiating a TDLS Peer connection between two legacy STAs.

For this known example, TDLS, allows two peer non-AP STAs to establish direct communication with each other. Once a TDLS link has been established, traffic flows directly between the peer STAs and is not bridged through the AP. TDLS can only be established between two STAs associated to the AP in the same BSS. The path of a frame is reduced from STA-AP-STA to STA-STA.

This above may also include TDLS security. The objective of TDLS security is to establish a direct link between legacy STA 1 and legacy STA 2, using an AP, e.g. a 2.4 GHZ AP to facilitate communication for discovery and setup. The STAs must be associated to the same AP in the same BSS. Once the security connection is established, data flows direct between the 2 STAs and not through the access point.

There are two stages to TDLS establishment: 1) TDLS Discovery; and 2) TDLS Setup.

TDLS Discovery: A STA determines that is communicating with a peer STA on a local LAN. This may be done at the application or network layer. The STA determines that it may be able to communicate directly with the peer STA through TDLS.

To discover whether a TDLS link is possible, the STA, e.g. legacy STA 1, transmits a TDLS Discovery Request frame to the peer STA. The TDLS Discovery request frame is transmitted to the peer STA, e.g. legacy STA 2, via an AP, e.g. the 2.4 GHz AP. In turn, the peer STA responds to the originating STA with a TDLS Discovery Response frame, via the 2.4 GHz AP. At this point the STA and the peer STA can determine whether they are connected to the same BSS, i.e. the same AP.

TDLS Setup: The STA then transmits a TDLS Setup Request frame to the peer STA via the 2.4 GHz AP. The peer STA processes the request, derives TDLS key material (the TDLS Peer Key), and responds with a TDLS Setup Response to the STA via the AP. The STA derives TDLS key material, successfully validates the TDLS Setup Response, and sends a TDLS Setup Confirm to the other STA, via the 2.4 GHz AP. The STA validates the TDLS Setup Confirm frame to complete the TDLS handshake.

At this point the STA and the peer STA can communicate directly with encapsulated traffic using the TDLS keying material. The STA and peer STA are now able to communicate directly over a secure connection while maintaining connectivity to the AP.

IEEE 802.11 includes a feature of MBSSID, allowing an AP to advertise multiple BSSs that are co-located using a single beacon. However, the BSSs are connected to separate ESS/DSs, so it is unclear that they provide connectivity to a single LAN.

A first use case example relating to FIG. 1 may be a meeting room, e.g. in a corporate office. A meeting room in a corporate office includes a projector that is connected to the corporate network via an AP in the room. The AP in the meeting room advertises two networks via MBSSID. The corporate network and the visitor network. The corporate network and visitor network are connected to separate LANs. A sales person with a mobile device visits the corporate office to give a presentation. They connect their mobile device to the visitor network. The sales person configures their mobile device to discover and connect to the projector.

A second use case example relating to FIG. 1 may be a home scenario. An AP in a residential environment advertises a home network and a guest network. Both BSSs are advertised by the AP using MBSSID and connect to the same LAN. A smart TV is connected to the home network in the living room. A friend of the family visits the house with their mobile device and wants to share videos of their trip. Their mobile device is connected to the guest network. The mobile device discovers and connects directly to the smart TV via the guest network to share videos.

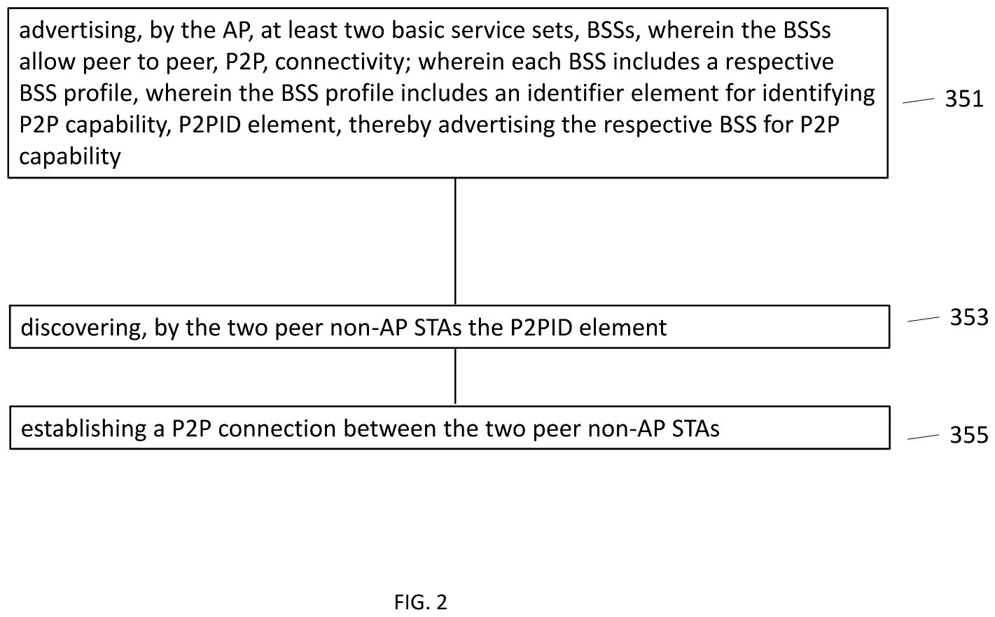

FIG. 2 illustrates a method of establishing direct communication between two peer non-access point, non-AP, stations, STAs according to an embodiment of the present disclosure. FIG. 2 illustrates a method of establishing direct communication between two peer non-access point, non-AP, stations, STAs, in a network environment including a plurality of networks, at least one AP and at least two non-AP STAs. The method in FIG. 2 comprises: a step 351 of advertising, by the AP, at least two basic service sets, BSSs, wherein the BSSs allow peer to peer, P2P, connectivity; wherein each BSS includes a respective BSS profile, wherein the BSS profile includes an identifier element for identifying P2P capability, P2PID element, thereby advertising the respective BSS for P2P capability. A step 353 of discovering, by the two peer non-AP STAs the P2PID element; and a step 355 of establishing a P2P connection between the two peer non-AP STAs.

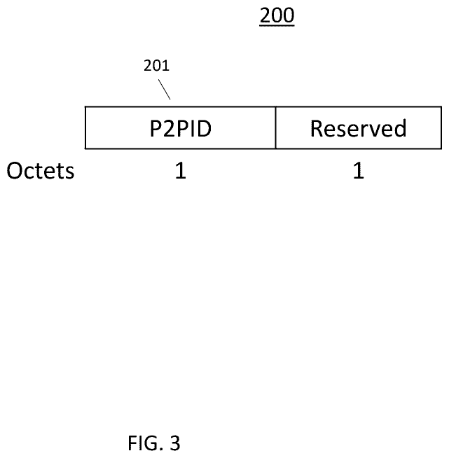

FIG. 3 illustrates a P2P identifier field 201 for a BSS profile 200 for advertising P2P connectivity, according to a first embodiment of the present disclosure. This embodiment thus relates to a P2P Identifier field for BSSs advertised through an MBSSID AP. It should be clear that FIG. 3 only illustrates a part of the BSS profile 200.

In more detail, FIG. 3 illustrates a new P2P Identifier field 201 in the BSS profile 200 for use in advertising a BSS that allows P2P connectivity. This new P2P identifier element 201 may be a field or new element. This new P2P element may be transmitted by an AP that hosts the BSSs. In the example shown in FIG. 3, the length of the P2PID field is 1 octet.

Here, the presence of a P2P Identifier element 201 advertises that the BSS, served by an AP, is capable of supporting P2P connectivity.

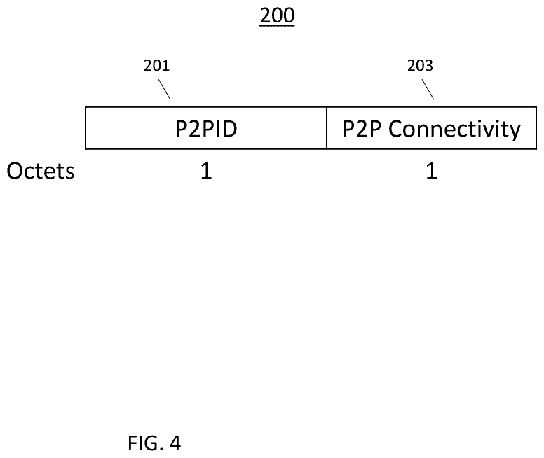

According to a further embodiment, FIG. 4 illustrates a BSS profile 200 similar to the BSS profile 200 in FIG. 3. FIG. 4 illustrates the P2P identifier field 201 similar to the P2P identifier field 201 of FIG. 3. In FIG. 4, the BSS profile 200 further includes a P2P connectivity subfield 203. In more detail, FIG. 4 illustrates a P2P Connectivity subfield 203 that provides properties for P2P connectivity. One of the properties provided for P2P connectivity may be whether the BSSs advertised by the P2PID are attached to the same LAN. Thus, the BSS profile 200 including the P2P Connectivity subfield 203 may be transmitted within a Beacon or Probe Response from an AP that supports the BSS. In more detail, in FIG. 4, the P2PID 201 allows the STAs to discover which peers to establish a P2P connection with, via the multiple BSSs. Another possible property would be with respect to the IP addressing used for the P2P connection. FIG. 4 thus illustrates an example P2P Identifier field 201 and a P2P Connectivity subfield 203. In this example, the length of the P2PID field 201 is 1 octet and the length of the P2P Connectivity subfield 203 is 1 octet.

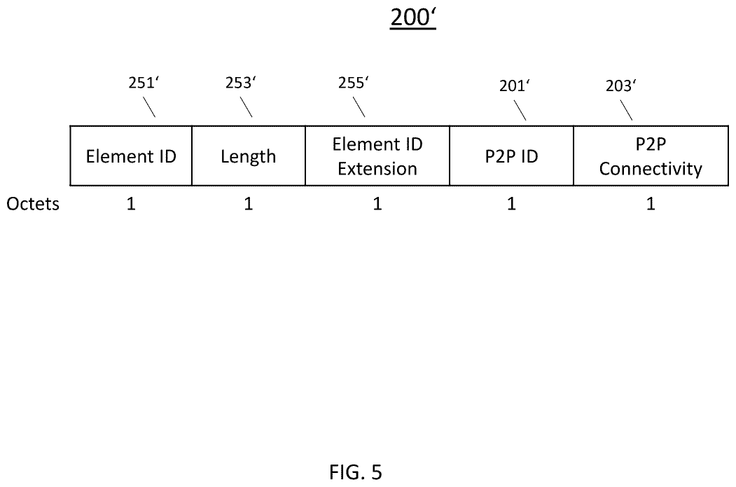

According to a variant of the embodiment shown in FIG. 4, FIG. 5 illustrates a BSS profile 200′ which is configured to serve as an element. The BSS profile 200′ shown in FIG. 5 is illustrated to include a subfield 251′ indicating an identifier of the Element, Element ID, a subfield 253′ indicating a Length of the Element, and a subfield 255′ indicating an Element ID extension. The BSS profile 200′ further includes a P2P identifier field 201′ similar to the P2P identifier field 201 of FIG. 3 and FIG. 4. The BSS profile 200′ further includes a P2P connectivity subfield 203′, similar to the P2P connectivity subfield 203 of FIG. 4. Thus, the P2P ID subfield 201′ and P2P Connectivity subfield 203′ may be carried as (sub) fields in a new element, i.e. the BSS profile 200′. This is useful in the case where the BSSs are advertised without MBSSID, i.e. with separate beacon frames. The subfields 201′ and 203′ may be included in this new element, BSS profile 200′, or on an existing element.

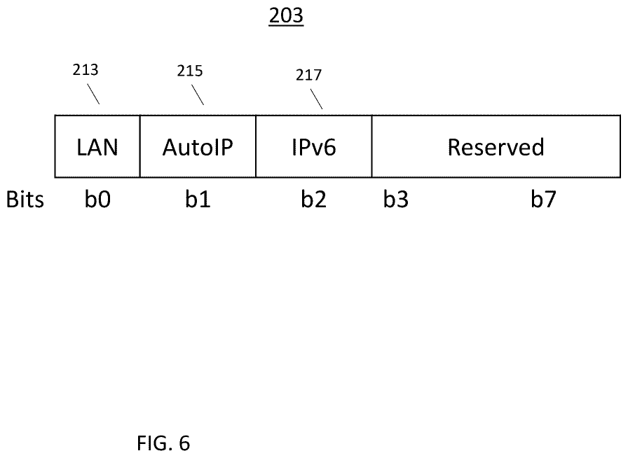

FIG. 6 further illustrates that for the P2P Connectivity subfield 203 as shown in FIG. 4 or likewise subfield 203′ as shown in FIG. 5, the bits may be defined as follows. The P2P Connectivity subfield 203 includes a subfield, LAN subfield 213, indicating whether the BSSs advertised by the P2P Identifier are on the LAN or not. The P2P Connectivity subfield 203 includes a subfield, Auto-IP subfield 215, indicating whether the P2P connection uses Auto-IP in IPV4. The P2P Connectivity subfield 203 further includes a subfield, IPv6 subfield 217, indicating whether the P2P connection uses IPV6. Here,

The bit in the subfield 213 indicates that the BSSs advertised by the P2P Identifier are connected to the same LAN. Here, a value of 0 indicates different LAN(s); a value of 1 indicates same LAN.

The bit in the subfield 215 indicates whether the P2P connection uses auto-IP in IPv4.

The bit in the subfield 217 indicates whether the P2P connection uses IPV6.

For this embodiment, FIG. 4, FIG. 5, and FIG. 6, the P2PID, cf. P2PID element 201, 201′, provides an indication to a STA that the BSS supports a particular P2P. If two STAs can discover the same P2PID, possibly in different BSSs, then it is possible that a P2P connection can be established between them.

The P2P Connectivity subfield 203 may provide extra information to a STA about the architecture/topology of the LAN and whether IPv4 or IPv6 are used.

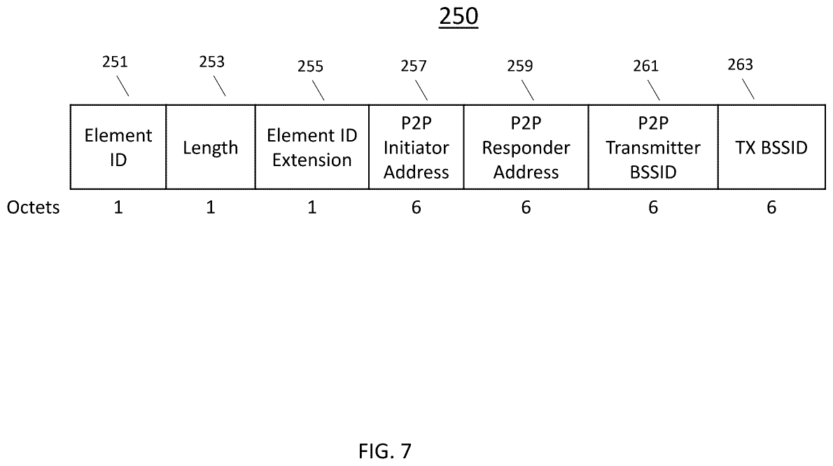

FIG. 7 illustrates an example for a P2P Link Identifier element 250, according to an embodiment of the present disclosure. The previous embodiments relate to the advertisement and discovery of the P2P connection. Here, the present embodiment relates to the establishment of the P2P connection. The P2P Link identifier element 250 provides the peer STA information for establishing the P2P connection. Therefore, the present embodiment relates to the earlier embodiments as the present embodiment describes the next step in the connection process after advertisement and discovery.

In FIG. 7, a P2P Link Identifier element 250 is added to prior art TDLS Discovery and Setup frames. The P2P Link identifier element 250 provides information to peer STAs that enable a P2P connection to be established between them. In more detail, in the example of the P2P Link Identifier element 250 shown in FIG. 7, the P2P Link identifier element 250 includes:
a subfield 257 including the MAC address of the P2P initiator
a subfield 259 including the MAC address of the P2P responder
a subfield 261 including the P2P Transmitter BSSID, where the P2P Transmitter BSSID is conditional depending on the transmitter of the frame, i.e.
a. for a TDLS Discovery Request frame, the P2P Transmitter BSSID is set to the P2P Initiator BSSID;
b. for a TDLS Discovery Response frame, the P2P Transmitter BSSID is set to the P2P Responder BSSID
c. for a TDLS Setup Request/Confirm, the P2P Transmitter BSSID set to the P2P Initiator BSSID, and
d. for a TDLS Setup Response frame, the P2P Transmitter BSSID set to the P2P Responder BSSID
a subfield 263 indicating the TX BSSID for the AP

P2P Link Identifier element 250 as shown in FIG. 7 further includes a subfield 251 indicating an identifier of the Element, Element ID, 251; a subfield 253 indicating a Length of the Element, and a subfield 255 indicating an Element ID extension.

Thus, the P2P Link Identifier element 250 as illustrated in FIG. 7 provides information, such addressing that allows two peer STAs to establish a P2P connection between them.

It should be appreciated that P2P Connectivity may be established by re-using prior art TDLS Discovery and Setup frames with the additional new P2P Link Identifier element similar as described in the embodiment of FIG. 7.

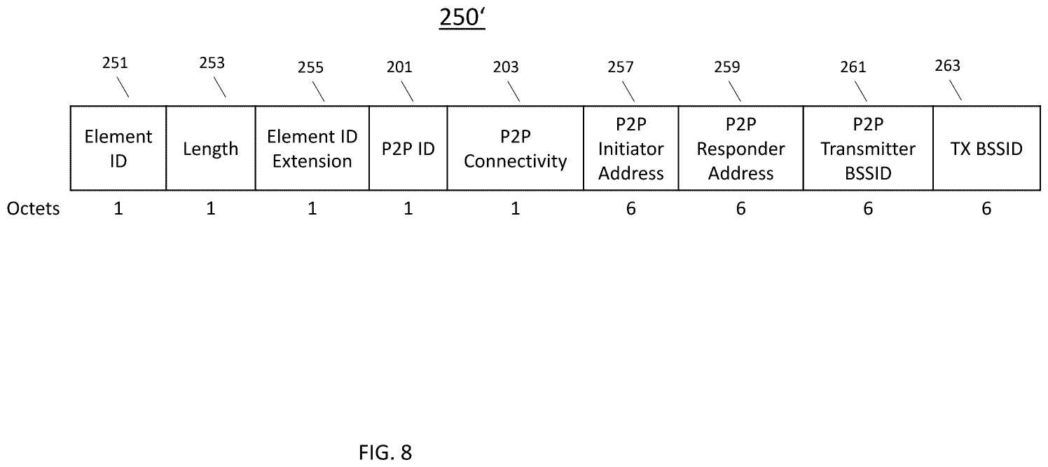

FIG. 8 illustrates a variant of the P2P Link Identifier element of FIG. 7, according to an embodiment of the present disclosure. In FIG. 8, a P2P Link Identifier element 250′ is shown. This P2P Link Identifier element 250′ includes the same elements as the P2P Link Identifier element 250 of FIG. 7 except that the element 250′ of FIG. 8 additionally includes the P2P identifier field 201 and the P2P connectivity subfield 203, cf. FIGS. 3, 4 and 5. This P2P Link Identifier element 250′ may be exchanged between the peers.

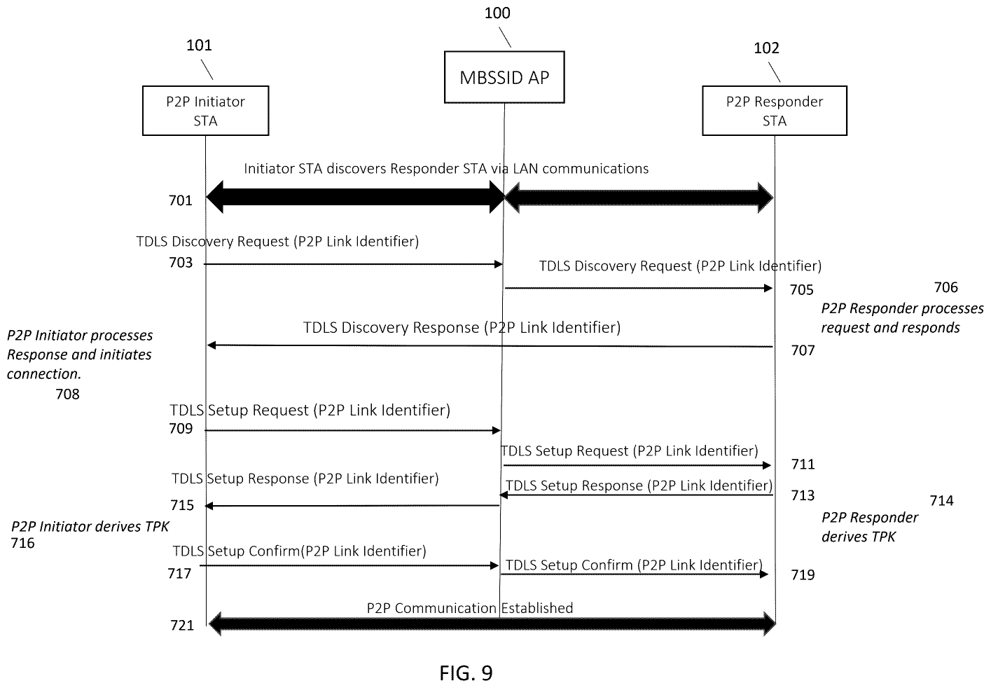

FIG. 9 illustrates details of a protocol flow showing establishment of a P2P connection, according to an embodiment of the present disclosure. FIG. 9 illustrates a communication between AP 100, capable of transmitting an MBSSID, denoted an MBSSID AP, and a first STA 101 being the P2P Initiator STA, and a second STA 102 being the P2P responder STA. It should be understood that the roles of STAs 101 and 102 may be reversed. The steps in FIG. 9 are described as follows:

In step 701, the P2P Initiator 101 discovers the P2P Responder 102 through the LAN, the MBSSID AP 100 communicating with each of the STAs 101 and 102, respectively. Here it should be noted that in case the peer STAs 101 and 102 operate on different LANs, IP service advertisement protocols could be used, or alternatively, the P2P initiator and the P2P responder could establish IP connectivity over the network.

In step 703, the P2P Initiator 101 sends a TDLS Discovery Request frame to P2P Responder 102, the TDLS Discovery Request frame including a P2P Link Identifier element, the TDLS Discovery Request frame being sent through the MBSSID AP 100.

In step 705, the P2P Responder 102 receives the TDLS Discovery Request frame of the P2P Initiator 101, communicated through the MBSSID AP 100.

In step 706, the P2P Responder 102 processes the received TDLS Discovery Request frame. That is, the P2P Responder 102 matches the P2P Responder 102 address and the TX BSSID.

In step 707, the P2P Responder 102 responds to the TDLS Discovery Request frame by sending a TDLS Discovery Response frame directly to the P2P Initiator. Here, directly sending the TDLS Discovery Response frame means that the TDLS Discovery Response frame is not communicated through the MBSSID AP 100 to P2P Initiator 101 with P2P Link Identifier element, but instead communication is directly between the P2P Responder 102 and the P2P Initiator 101.

In step 708, the P2P Initiator 101, having directly received the TDLS Discovery Response frame from the P2P Responder 102, processes the TDLS Discovery Response frame. That is, the P2P Initiator 101 validates the P2P Initiator 101 address and TX BSSID in the received TDLS Discovery Response frame and initiates connection with the P2P Responder 102. Thus, the P2P Initiator 101 begins link setup and, in step 709, the P2P Initiator 101 transmits a TDLS Setup Request frame to the P2P Responder 102 via the MBSSID AP 100.

The MBSSID AP 100 communicates the TDLS Setup Request frame to the P2P Responder 102 and in step 711, the P2P Responder 102 receives the TDLS Setup Request frame.

In step 713, the P2P Responder 102 replies with a TDLS Setup Response frame to the P2P Initiator 101 via the MBSSID AP 100, and in step 714 the P2P Responder 102 derives a TPK.

In step 715 the P2P Initiator 101 receives the TDLS Setup Response frame from the P2P Responder 102, communicated via the MBSSID AP 100, and in step 716, the P2P Initiator 101 derives the TPK. Then, in step 717, the P2P Initiator 101 replies to the P2P Initiator 101 with a TDLS Setup Confirm frame communicated via the MBSSID AP 100. In step 719, the P2P Responder receives the TDLS Setup Confirm frame.

Finally, in step 721, direct P2P communication between the P2P Initiator 101 and the P2P Responder 102 is established.

Thus, using modified TDLS frames provides establishing a P2P connection between the peer STAs.

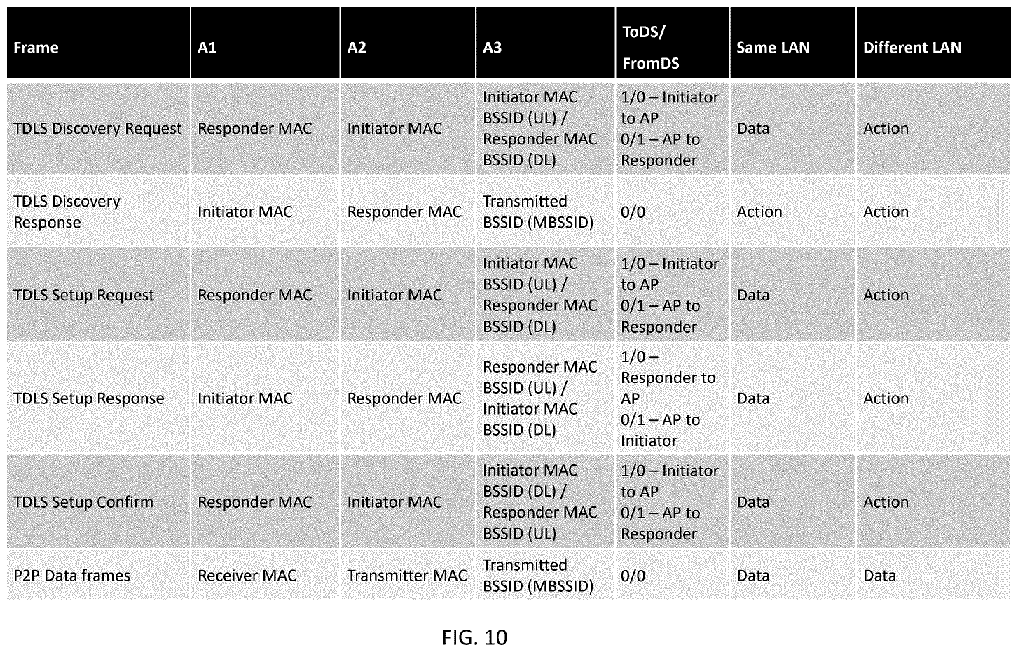

Relating to the embodiment of FIG. 9, FIG. 10 illustrates a table including specific addressing with respect to the frames shown in FIG. 9.

The prior art TDLS mechanism uses data frames with an Ether Type of 89-0d and a Payload Type of 2 to communicate TDLS Discovery Request and TDLS Setup Request/Response/Confirm frames. In the following, for brevity, the term “frame(s)” may be dropped and it is simply referred to TDLS Discovery Request and TDLS Setup Request/Response/Confirm. For P2P connectivity use, enhanced TDLS frames would be re-purposed, by using a new Payload Type value. FIG. 10 shows the IEEE 802.11 A1, A2, A3 addresses and their values, according to the present disclosure.

Each row of the table shown in FIG. 10 indicates one of TDLS Discovery Request and TDLS Setup Request/Response/Confirm, and finally P2P Data frames. The values of the A1, A2 and A3 subfields are given. For brevity, the P2P responder is referred to as Responder, and the P2P Initiator is referred to as Initiator. Further, in FIG. 10, the table values of ToDS and FromDS subfields are given. ToDS and FromDS are subfields of the Frame Control field. Further, in FIG. 10, in the table SameLAN and DifferentLAN indicate the TDLS frame types depending upon whether the two peer non-AP STAs are on the same LAN or are on different LANs, respectively.

Thus, the P2P addressing shown in FIG. 10 provides for re-using the prior art TDLS frames for P2P Connectivity.

As already indicated for FIG. 9, the P2P Responder and the P2P Initiator each derive a TPK. Here, the security for the P2P link is dependent on the MBSSID AP, the BSS of the P2P Initiator and the BSS of the P2P Responder. The key derivation should reflect these properties.

An example TPK generation is as follows:
TPK-Key-Input=Hash (min (SNonce, ANonce)∥max (SNonce, ANonce))
TPK=KDF-Hash-Length (TPK-Key-Input, “P2P Setup PMK”, min (MAC_I, MAC_R)∥max (MAC_I, MAC_R)∥Initiator BSSID∥Responder BSSID∥P2P Identifier∥BSSID initiator∥BSSID_responder∥Transmitted BSSID)

Here, the new values with respect to FIG. 9 and FIG. 10 for the present disclosure have been underlined. The key derivation function, KDF, is according to IEEE 802.11. Further, “∥” denotes an “or” operator.

The values are as follows:

The prior art values MAC_I and MAC_R are set to the P2P Initiator and P2P Responder MAC addresses

The BSSID of P2P Initiator and P2P Responder are the BSSs of the respective P2P Initiator and P2P Responder STAs.

The Transmitted BSSID is the transmitted BSSID, i.e. MBSSID, of the AP

Here, the TPK derivation may include a subset of P2P Identifier, BSSID P2P Initiator/Responder, and transmitted BSSID. It should be understood that one or more of the new values may be utilized. Further, not all the new values need to be utilized.

Thus, the security key of the established P2P connection is bound to the P2P initiator, responder and the intermediate AP hosting the BSSs.

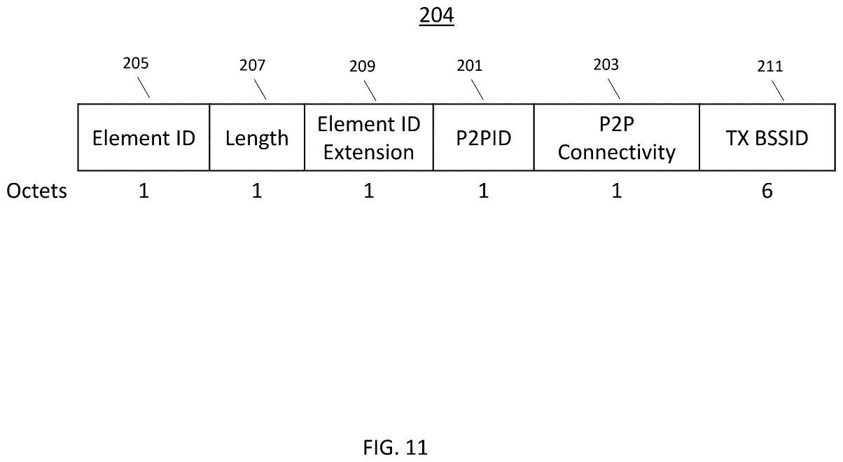

FIG. 11 relates to a further possibility for establishing a P2P connection. An AP that advertises co-located BSSs may transmit separate beacons for each hosted BSS. In this case there is no need for an MBSSID element advertising multiple BSSs.

In this case, there is no TX BSSID, i.e. to carry the MBSSID element, such that the TX BSSID is set to the BSSID of the Initiator peer STA.

FIG. 11 thus illustrates a P2P Connectivity element 204 to allow an AP to advertise BSSs where P2P connectivity is allowed. The P2P Connectivity element 204 is advertised through separate Beacons or Probe Responses. An example P2P Connectivity element 204 is shown in FIG. 11.

In FIG. 11, the P2P Connectivity element 204, includes a subfield 205 indicating an Element ID and a subfield 207 indicating a Length of the element. The P2P Connectivity element 204 further includes a P2PID subfield 201, similar to the P2PID subfield in FIGS. 3, 4 and 5. The P2P Connectivity element 204 in FIG. 11 further includes a P2P Connectivity subfield 203. The P2P Connectivity element 204 further includes a subfield 211 indicating the transmitter BSSID. Here, the subfield 211 indicating the TX BSSID includes the common transmitted BSSID used to exchange P2P frames between the peer STAs. The peer STAs would use the address provided in the subfield indicated TX BSSID as the transmitted BSSID.

Thus, for FIG. 11, TX BSSID address would be used in the same manner as the transmitted BSSID for the case where the AP advertises BSSs using the MBSSID.

Thus, the P2P Connectivity element 204 can be transmitted within multiple beacon frames when BSSs are co-located within the same AP.

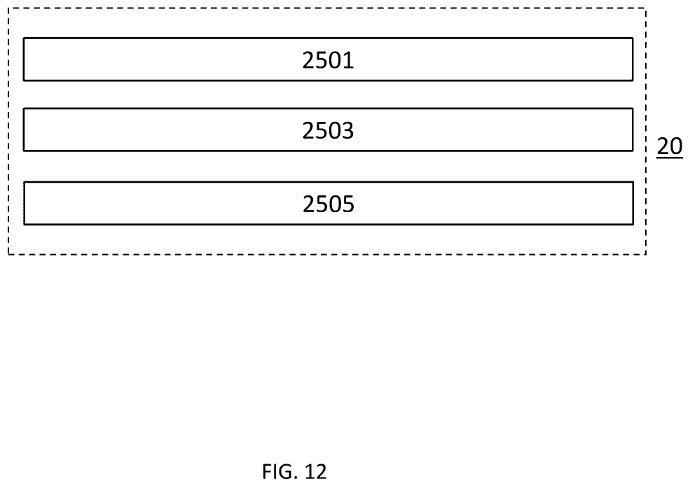

FIG. 12 illustrates a system 20 according to a further embodiment of the present disclosure. In FIG. 12, the system 20 is a system for establishing direct communication between two peer non-access point, non-AP, stations, STAs, in a network environment including a plurality of networks, at least one AP and at least two non-AP STAs. In FIG. 12, the AP comprises an advertising unit 2501, wherein the advertising unit 2501 is configured to advertise at least two basic service sets, BSSs, wherein the BSSs allow peer to peer, P2P, connectivity; wherein each BSS includes a respective BSS profile, wherein the BSS profile includes an identifier element for identifying P2P capability, P2PID element, thereby advertising the respective BSS for P2P capability; wherein each of the two peer non-AP STAs comprises a discovering unit 2503, wherein each discovering unit of the two peer non-AP STAs is configured to discover the P2PID element, respectively; and wherein each of the two peer non-AP STAs comprises a connecting unit 2505, wherein each of the connecting units 2505 is configured to establish a P2P connection between the two peer non-AP STAs, respectively.

### Abbreviations

AKM authentication and key management
DA destination address
DL downlink
EHT extremely high throughput
LAN local area network
RA receiver address
RSNE robust security network element
SA security association
SAP service access point
STA station
TA transmitter address
TDLS tunneled direct link setup
TG task group
TPK TDLS key derivation
UL uplink
WLAN wireless local area network

1. A method of establishing direct communication between two peer non-access point, non-AP, stations, STAs, in a network environment including a plurality of networks, at least one AP and at least two non-AP STAs, the method comprising:
(351) advertising, by the AP, at least two basic service sets, BSSs, wherein the BSSs allow peer to peer, P2P, connectivity;
wherein each BSS includes a respective BSS profile (200), wherein the BSS profile (200) includes an identifier element for identifying P2P capability, P2PID element (201), thereby advertising the respective BSS for P2P capability;
(353) discovering, by the two peer non-AP STAs the P2PID element (201); and
(353) establishing a P2P connection between the two peer non-AP STAs.

2. The method according to claim 1, wherein the BSS profile further includes a subfield indicating P2P connectivity, P2P Connectivity Subfield (203).

3. The method according to claim 2, wherein in case the BSSs are co-located, transmitting, by the AP, separate beacons for each BSS hosted by the AP, wherein advertising by the AP uses separate beacons, wherein each of the separate beacons of the BSS profile includes an element for allowing the AP to advertise BSSs where P2P connectivity is allowed, P2P Connectivity, P2P Connectivity element (204).

4. The method according to claim 3, wherein the P2P Connectivity element (204) includes at least the following subfields:
a subfield (201) indicating the identifier element for identifying P2P capability, P2PID element (201);
the subfield (203) indicating P2P connectivity;
a subfield (211) indicating the BSSID of the transmitter, TX BSSID, wherein the TX BSSID is set to the BSSID of the P2P initiator.

5. The method according to claim 1, wherein advertising, by the AP, uses Multiple BSSID, MBSSID, to advertise the at least two BSSs.

6. The method according to claim 5, wherein the BSSID of the transmitter, TX BSSID, is equivalent to the MBSSID of the AP.

7. The method according to claim 6, wherein the P2P Connectivity Subfield (203) includes one or more of the following properties:
a property indicating whether the BSSs advertised by the P2PID element (201) are connected to the same LAN or different LANs;
a property indicating whether the P2P connection uses auto-IP in IPV4; and
a property indicating whether the P2P connection uses IPv6.

8. The method according to claim 1, wherein:
the identifier element (201) for identifying P2P is an identifier for identifying a P2P link, P2P Link Identifier element (250).

9. The method according to claim 8, wherein the P2P Link Identifier element (250) includes at least the following subfields:
a subfield (257) indicating a P2P initiator MAC address;
a subfield (259) indicating a P2P responder MAC address;
a subfield (261) indicating a BSSID of a P2P transmitter, wherein the BSSID of the P2P transmitter is set depending on the type of the frame to be:
the BSSID of the P2P initiator, in case a TDLS Discovery Request frame is transmitted;
the BSSID of the P2P responder, in case a TDLS Discovery Response frame is transmitted;
the BSSID of the P2P initiator, in case a TDLS Setup Request or a TDLS Setup Confirm frame is transmitted;
the BSSID of the P2P responder, in case a TDLS Setup Response frame is transmitted;
and
a subfield (263) indicating a TX BSSID for the AP.

10. The method according to claim 9, further comprising:
one of the two peer non-AP STAs being the initiator (101) of the P2P, the other one of the two peer non-AP STAs being the responder (102) of the P2P, wherein the P2P initiator (101), the P2P responder (102) and the AP (100) communicate via tunneled direct link setup, TDLS, frames; wherein the method further comprises:
providing, by the P2P initiator (101), a predefined TDLS Discovery Request frame;
modifying the predefined TDLS Discovery Request frame by adding the P2P Link Identifier element to the TDLS Discovery Request frame, thereby obtaining a modified TDLS Discovery Request frame;
transmitting, by the P2P initiator (101), the modified TDLS Discovery request frame to the P2P responder (102) via the AP;
matching, by the P2P responder (102), the received modified TDLS Discovery request frame with the address and TX BSSID of the P2P initiator (101);
directly responding, by the P2P responder (102), to the P2P initiator (101), with a TDLS Discovery Response frame using the P2P Link Identifier element;
validating, by the P2P initiator (101), the P2P initiator (101) address and TX BSSID in the received TDLS Discovery Response frame from the P2P responder (102);
providing, by the P2P initiator (101), a predefined TDLS Setup Request frame;
modifying the predefined TDLS Discovery Setup Request frame by adding the P2P Link Identifier element to the TDLS Setup Request frame, thereby obtaining a modified TDLS Setup Request frame;
setting up the P2P link by the P2P initiator (101) by transmitting the modified TDLS Setup Request frame to the P2P responder (102) via the AP;
after receiving, by the P2P responder (102), the modified TDLS Setup Request frame via the AP, responding, by the P2P responder (102), to the P2P initiator (101) via the AP by sending a TDLS Setup response frame and deriving, by the P2P responder (102), a TDLS peer key, TPK;
receiving, by the P2P initiator (101), the TDLS Setup Response frame from the P2P responder (102) via the AP, and deriving, by the P2P initiator (101), the TPK, and responding, by the P2P initiator (101), to the P2P responder (102) via the AP with a TDLS Setup Confirm frame.

11. The method according to claim 10, wherein the modified TDLS Discovery request frame, the TDLS Setup Request frame, the TDLS Setup Response frame, and the TDLS Confirm frame are transmitted between the P2P initiator STA (101) and P2P responder STA (102) as management frames according to IEEE 802.11, wherein these management frames comprise subfields according to:

| | | | | | Same | Different |
|---|---|---|---|---|---|---|
| Frame | A1 | A2 | A3 | ToDS/FromDS | LAN | LAN |
| TDLS | Responder | Initiator | Initiator | 1/0 - | Data | Action |
| Discovery | MAC | MAC | MAC | Initiator to | | |
| Request | | | BSSID for | AP | | |
| | | | UL/ | 0/1 - AP to | | |
| | | | Responder | Responder | | |
| | | | MAC | | | |
| | | | BSSID for | | | |
| | | | DL | | | |
| TDLS | Initiator | Responder | Transmitted | 0/0 | Action | Action |
| Discovery | MAC | MAC | BSSID | | | |
| Response | | | | | | |
| TDLS | Responder | Initiator | Initiator | 1/0 - | Data | Action |
| Setup | MAC | MAC | MAC | Initiator to | | |
| Request | | | BSSID for | AP | | |
| | | | UL/ | 0/1 - AP to | | |
| | | | Responder | Responder | | |
| | | | MAC | | | |
| | | | BSSID for | | | |
| | | | DL | | | |
| TDLS | Initiator | Responder | Responder | 1/0 - | Data | Action |
| Setup | MAC | MAC | MAC | Responder | | |
| Response | | | BSSID for | to AP | | |
| | | | UL/ Initiator | 0/1 - AP to | | |
| | | | MAC | Initiator | | |
| | | | BSSID for | | | |
| | | | DL | | | |
| TDLS | Responder | Initiator | Initiator | 1/0 - | Data | Action |
| Setup | MAC | MAC | MAC | Initiator to | | |
| Confirm | | | BSSID for | AP | | |
| | | | DL/ | 0/1 - AP to | | |
| | | | Responder | Responder | | |
| | | | MAC | | | |
| | | | BSSID for | | | |
| | | | UL | | | |
| TDLS | Responder | Transmitter | Transmitted | 0/0 | Data | Data |
| Data | MAC | MAC | BSSID | | | |
| frames | | | | | | |

where A1, A2 and A3 are addresses according to IEEE 802.11, ToDS and FromDS are subfields of the Frame Control field, SameLAN and DifferentLAN indicate the TDLS frame types depending upon whether the two peer non-AP STAs are on the same LAN or are on different LANs, respectively.

12. The method according to claim 10, wherein the deriving of the TPK comprises:
generating an input for deriving the TPK, TPK-Key-Input;
deriving the TPK using a predefined key derivation function, KDF,
wherein the KDF arguments include the TPK-Key-Input and one or more of: the minimum of the numerical value of the MAC address of the MAC addresses of the P2P initiator (101) and the P2P responder (102), the maximum of the numerical value of the MAC address of the MAC addresses of the P2P initiator (101) and the P2P responder (102), the P2P identifier element, the BSSID of the P2P initiator (101), the BSSID of the P2P responder (102), and the transmitted BSSID;
wherein the BSSID of the P2P initiator (101) is the identifier of the BSS of the respective P2P initiator STA (101), the BSSID of the P2P responder (102) is the identifier of the BSS of the P2P responder STA (102).

13. A system for establishing direct communication between two peer non-access point, non-AP, stations, STAs, in a network environment including a plurality of networks, at least one AP and at least two non-AP STAs, wherein:
the AP is configured to advertise at least two basic service sets, BSSs, wherein the BSSs allow peer to peer, P2P, connectivity;
wherein each BSS includes a respective BSS profile, wherein the BSS profile includes an identifier element for identifying P2P capability, P2PID element (201), thereby advertising the respective BSS for P2P capability;
wherein the two peer non-AP STAs are configured to discover the P2PID element (201); and
the two peer non-AP STAs are configured to establish a P2P connection between the two peer non-AP STAs.

14. The system according to claim 13, wherein the BSS profile further includes a subfield indicating P2P connectivity, P2P Connectivity Subfield (203).

15. The system according to claim 14, wherein in case the BSSs are co-located, the AP is configured to transmit separate beacons for each BSS hosted by the AP, wherein the AP is configured to use separate beacons for advertising, wherein each of the separate beacons of the BSS profile includes an element for allowing the AP to advertise BSSs where P2P connectivity is allowed, P2P Connectivity element (204).

16. The system according to claim 15, wherein the P2P Connectivity element (204) includes at least the following subfields:
a subfield indicating the identifier element for identifying P2P capability, P2PID element (201);
the subfield indicating P2P connectivity;
a subfield indicating the BSSID of the transmitter, TX BSSID, wherein the TX BSSID is set to the BSSID of the P2P initiator (101).

17. The system according to claim 13, wherein the AP is configured to use Multiple BSSID, MBSSID, to advertise the at least two BSSs.

18. The system according to claim 17, wherein the BSSID of the transmitter, TX BSSID, is equivalent to the MBSSID of the AP.

19. The system according to claim 18, wherein the P2P Connectivity Subfield (203) includes one or more of the following properties:
a property indicating whether the BSSs advertised by the P2PID element (201) are connected to the same LAN or different LANs;
a property indicating whether the P2P connection uses auto-IP in IPV4; and
a property indicating whether the P2P connection uses IPV6.

20. The system according to claim 13, wherein:
the identifier element for identifying P2P is an identifier for identifying a P2P link, P2P Link Identifier element.
